(19) United States
(12) Patent Application Publication
(10) Pub. No.: US 2021/0053194 A1
(43) Pub. Date: Feb. 25, 2021

(54) Harmonic Balancer Stabilizer Apparatus

(71) Applicant: Roy Matson, Nevada, MO (US)

(72) Inventor: Roy Matson, Nevada, MO (US)

(21) Appl. No.: 16/545,897

(22) Filed: Aug. 20, 2019

(51) Int. Cl. B25B 13/48; B25B 27/00

(52) U.S. Cl. CPC B25B 13/48; B25B 27/0035

(57) ABSTRACT

A harmonic balancer stabilizer apparatus for removing engine harmonic balancers includes a wrench body having a top side, a bottom side, a front end, a back end, a left edge, and a right edge. The wrench body has a principal aperture extending from the top side through the bottom side proximal the front end. The wrench body has a plurality of auxiliary apertures extending from the top side through the bottom side adjacent the principal aperture. Each of the plurality of auxiliary apertures is distributed around a perimeter of the principal aperture a fixed distance from the perimeter.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including Information disclosed under 37 CFR 1.97 and 1.98

The disclosure and prior art relates to wrenches and more particularly pertains to a new wrench for removing engine harmonic balancers.

### BRIEF SUMMARY OF THE INVENTION

An embodiment of the disclosure meets the needs presented above by generally comprising a wrench body having a top side, a bottom side, a front end, a back end, a left edge, and a right edge. The wrench body has a principal aperture extending from the top side through the bottom side proximal the front end. The wrench body has a plurality of auxiliary apertures extending from the top side through the bottom side adjacent the principal aperture. Each of the plurality of auxiliary apertures is distributed around a perimeter of the principal aperture a fixed distance from the perimeter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

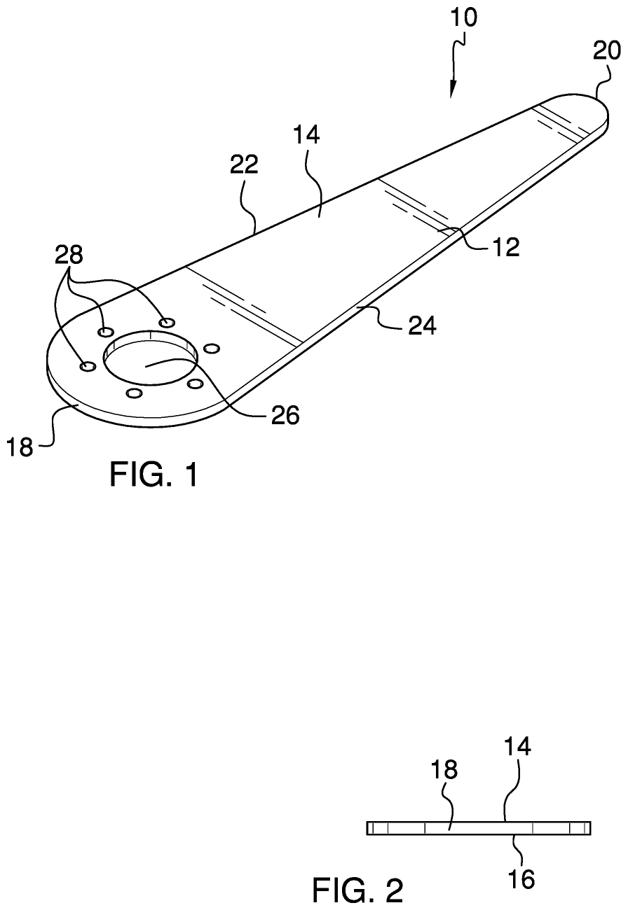

FIG. 1 is an isometric view of a harmonic balancer stabilizer apparatus according to an embodiment of the disclosure.

FIG. 2 is a side elevation view of an embodiment of the disclosure.

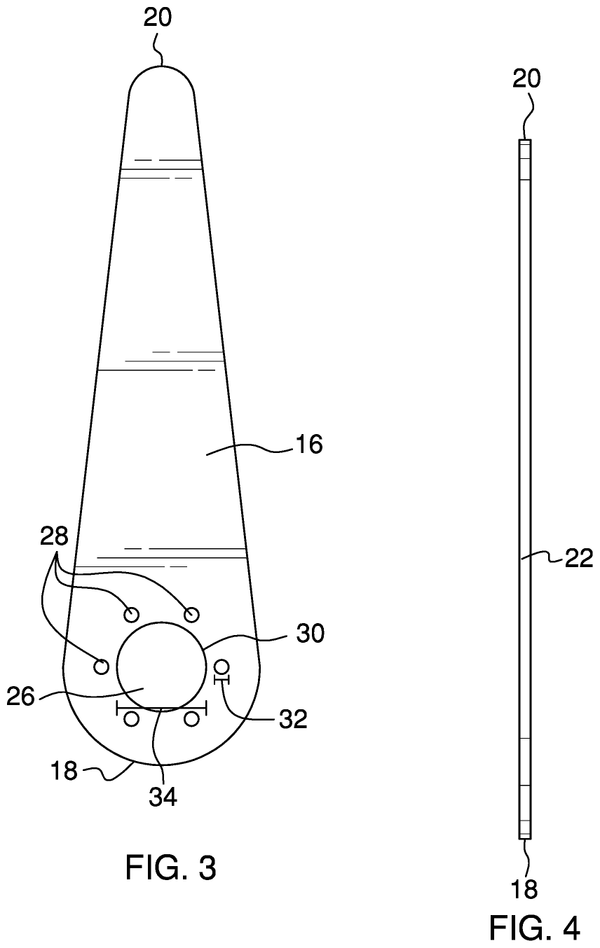

FIG. 3 is a bottom plan view of an embodiment of the disclosure.

FIG. 4 is a side elevation view of an embodiment of the disclosure.

### DETAILED DESCRIPTION OF THE INVENTION

With reference now to the drawings, and in particular to FIGS. 1 through 4 thereof, a new wrench embodying the principles and concepts of an embodiment of the disclosure and generally designated by the reference numeral 10 will be described.

As best illustrated in FIGS. 1 through 4, the harmonic balancer stabilizer apparatus 10 generally comprises a wrench body 12 having a top side 14, a bottom side 16, a front end 18, a back end 20, a left edge 22, and a right edge 24. Each of the front end 18 and the back end 20 is semicircular. The left edge 22 and the right edge 24 taper from the front end 18 to the back end 20. The wrench body 12 may have a vertical line of symmetry extending from the front end 18 to the back end 20. A diameter of the front end 18 may be at least three times greater than a diameter of the back end 20. A length of the wrench body 12 may be between 3.5 and 4.7 times the diameter of the front end 18. The wrench body 12 has a principal aperture 26 extending from the top side 14 through the bottom side 16 proximal the front end 18. The semicircular front end 18 is concentric with the principal aperture 26. The wrench body 12 has a plurality of auxiliary apertures 28 extending from the top side 14 through the bottom side 16 adjacent the principal aperture 26. Each of the plurality of auxiliary apertures 28 is distributed around a perimeter 30 of the principal aperture 26 a fixed distance from the perimeter 30. The plurality of auxiliary apertures 28 may comprise six auxiliary apertures 28 evenly radially distributed around the perimeter 30 of the principal aperture 26. Each of the plurality of auxiliary apertures 28 may have an auxiliary diameter 32 less than 20% of a principal diameter 34 of the principal aperture 26.

In use, the principle aperture 26 and the auxiliary apertures 28 are engaged around a harmonic balancer of a vehicle. The back end 20 of the wrench body is secured against a frame of the vehicle to prevent the harmonic balancer from turning when applying torque during repair.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A harmonic balancer stabilizer apparatus comprising:
a wrench body, the wrench body having a top side, a bottom side, a front end, a back end, a left edge, and a right edge;
the wrench body having a principal aperture extending from the top side through the bottom side proximal the front end; and
the wrench body having a plurality of auxiliary apertures extending from the top side through the bottom side adjacent the principal aperture, each of the plurality of auxiliary apertures being distributed around a perimeter of the principal aperture a fixed distance from the perimeter.

2. The harmonic balancer stabilizer apparatus of claim 1 further comprising each of the front end and the back end being rounded.

3. The harmonic balancer stabilizer apparatus of claim 1 further comprising each of the front end and the back end being semicircular.

4. The harmonic balancer stabilizer apparatus of claim 3 further comprising the semicircular front end being concentric with the principal aperture.

5. The harmonic balancer stabilizer apparatus of claim 1 further comprising the left edge and the right edge tapering from the front end to the back end.

6. The harmonic balancer stabilizer apparatus of claim 1 further comprising the plurality of auxiliary apertures being evenly radially distributed around the perimeter of the principal aperture.

7. The harmonic balancer stabilizer apparatus of claim 6 further comprising the plurality of auxiliary apertures being six auxiliary apertures.

8. The harmonic balancer stabilizer apparatus of claim 1 further comprising each of the plurality of auxiliary apertures having an auxiliary diameter less than 20% of a principal diameter of the principal aperture.

9. The harmonic balancer stabilizer apparatus of claim 3 further comprising a diameter of the front end being at least three times greater than a diameter of the back end.

10. The harmonic balancer stabilizer apparatus of claim 9 further comprising a length of the wrench body being between 3.5 and 4.7 times the diameter of the front end.

11. A harmonic balancer stabilizer apparatus comprising:
a wrench body, the wrench body having a top side, a bottom side, a front end, a back end, a left edge, and a right edge, each of the front end and the back end being semicircular, the left edge and the right edge tapering from the front end to the back end;
the wrench body having a principal aperture extending from the top side through the bottom side proximal the front end, the semicircular front end being concentric with the principal aperture; and
the wrench body having a plurality of auxiliary apertures extending from the top side through the bottom side adjacent the principal aperture, each of the plurality of auxiliary apertures being distributed around a perimeter of the principal aperture a fixed distance from the perimeter, the plurality of auxiliary apertures comprising six auxiliary apertures evenly radially distributed around the perimeter of the principal aperture, each of the plurality of auxiliary apertures having an auxiliary diameter less than 20% of a principal diameter of the principal aperture.
